(19) United States
(12) Patent Application Publication
(10) Pub. No.: US 2021/0166239 A1
(43) Pub. Date: Jun. 3, 2021

(54) PAYMENT ASSISTANCE SYSTEM AND PAYMENT ASSISTANCE METHOD

(71) Applicant: Hiroki Matsudaira, Tokyo (JP)

(72) Inventor: Hiroki Matsudaira, Tokyo (JP)

(21) Appl. No.: 17/156,854

(22) Filed: Jan. 25, 2021

Related U.S. Application Data
(63) Continuation of application No. PCT/JP2019/028591, filed on Jul. 22, 2019.

(30) Foreign Application Priority Data
Jul. 24, 2018 (JP) 2018-138243

(51) Int. Cl. G06Q 20/40; G06Q 20/06; G06Q 30/06; G06F 16/955

(52) U.S. Cl. CPC G06Q 20/4037; G06Q 20/065; G06Q 40/02; G06F 16/9566; G06Q 30/0623

(57) ABSTRACT

Provided is an environment in which balance information can be easily confirmed when a virtual currency is settled. The intermediary web page 110 corresponds to a URL address based on the merchandise identification information of the merchandise selected by a purchaser on the merchant web page 100. The authentication unit 120 authenticates the purchaser who has accessed the intermediary web page via the merchant web page 100. The acquisition unit 130 accesses the block chain based on the registration information of the purchaser authenticated by the authentication unit 120 to acquire the balance information of the virtual currency of the purchaser. The reflecting unit 140 reflects the balance information acquired by the acquiring unit 130 on the intermediary web page 110.

### RELATED APPLICATIONS

This application claims priority under 35 U.S.C. § 120 to, and is a continuation of, co-pending International Application PCT/JP2019/028591, filed Jul. 22, 2019 and designating the US, which claims priority to Japanese Application 2018-138243, filed Jul. 24, 2018, such Japanese Application also being claimed priority to under 35 U.S.C. § 119. These Japanese and International applications are incorporated by reference herein in their entireties.

### BACKGROUND

### Field

The present invention relates to a system and method for assisting in settlement when a purchaser purchases a product from a seller.

The use of virtual currency has become widespread in recent years, and an environment in which virtual currency can be used is increasing even in the payment of purchase. In the payment by the virtual currency, access to the block chain is required every time. It is troublesome to input a password or a secret key every time settlement is performed, and security concerns are also present.

In order to solve this problem, for example, there is disclosed a network system in which the balance of the virtual currency is recorded in association with the user s personal information and the balance of the virtual currency is recorded in association with a unique user ID for each user, and the amount of the virtual currency is added or subtracted in accordance with a purchase request or a consumption request specifying a card ID associated with the user ID (See JP-A-2015-146199).

In this way, balance inquiries and settlement have been performed in a system different from the system for selling merchandise.

Since the balance inquiry and the settlement are performed in a system different from the system that sells the product, it is necessary to use another system that handles the virtual currency while using the system that sells the product.

In the case of the conventional virtual currency settlement system when there is a product to be purchased, it is not possible to display and confirm the correct balance on the same screen as the screen on which the product desired to be purchased is displayed, and the screen of another system is confirmed via his/her password or secret key each time. Therefore, there is a problem that it was difficult to view. In addition, even at the time of payment, it could not be completed on the same screen in which the product is displayed. Therefore, there has been a demand for providing an environment in which balance information is confirmed and easily settled when the virtual currency is settled.

### SUMMARY

The payment assistance system according to the present invention includes: an intermediary web page corresponding to a URL address based on product identification information of a product selected by a purchaser on a merchant web page; an authentication unit that authenticates the purchaser who has accessed the intermediary web page via the merchant web page; an acquisition unit configured to acquire balance information of a virtual currency of the purchaser by accessing a block chain based on registration information of the purchaser authenticated by the authentication unit; and a reflection unit configured to reflect the balance information acquired by the acquisition unit in the intermediary web page.

According to the present invention, since the intermediary web page corresponds to the URL address based on the product identification information of the product, the intermediary web page can be captured and displayed in the merchant web page when the purchaser selects the item. Since the authentication process necessary for checking the balance of the virtual currency can be collected by the intermediary web page, it is possible to realize the balance display without directly transferring the secret key to the merchant web page server at the time of balance confirmation. Therefore, it is not necessary to perform the management of the secret key on the merchant web page, and payment processing without switching the screen can be realized.

### BRIEF DESCRIPTION OF DRAWINGS

FIG. 1 is a network configuration diagram to which the payment assistance system according to the present embodiment is applied.

FIG. 2 is a functional block diagram of a payment assistance system according to the present embodiment.

FIG. 3 is a flowchart of a pre-process of purchase acceptance via a virtual currency.

FIG. 4 is a product purchasing component creation screen.

FIG. 5 is a flowchart of purchase processing via virtual currency.

FIG. 6 is a display screen of a product purchase ticket before a product is purchased.

FIG. 7 is a product purchase ticket display screen after the product is purchased.

FIG. 8 is a flowchart showing a method of dispensing a seller in the case of virtual currency.

FIG. 9 is a flowchart of a process before purchase acceptance via a bank account.

FIG. 10 is a flowchart of a purchase process via a bank account.

FIG. 11 is a flowchart illustrating a method of dispensing a seller in the case of a bank account.

FIG. 12 is a flowchart of balance display processing by a payment channel via a virtual currency.

FIG. 13 is a flowchart of a purchase process by a payment channel via a virtual currency.

FIG. 14 is a flowchart illustrating a method for a purchaser side trading of a virtual currency.

FIG. 15 is a flowchart illustrating a method for dispensing a virtual currency.

### DETAILED DESCRIPTION

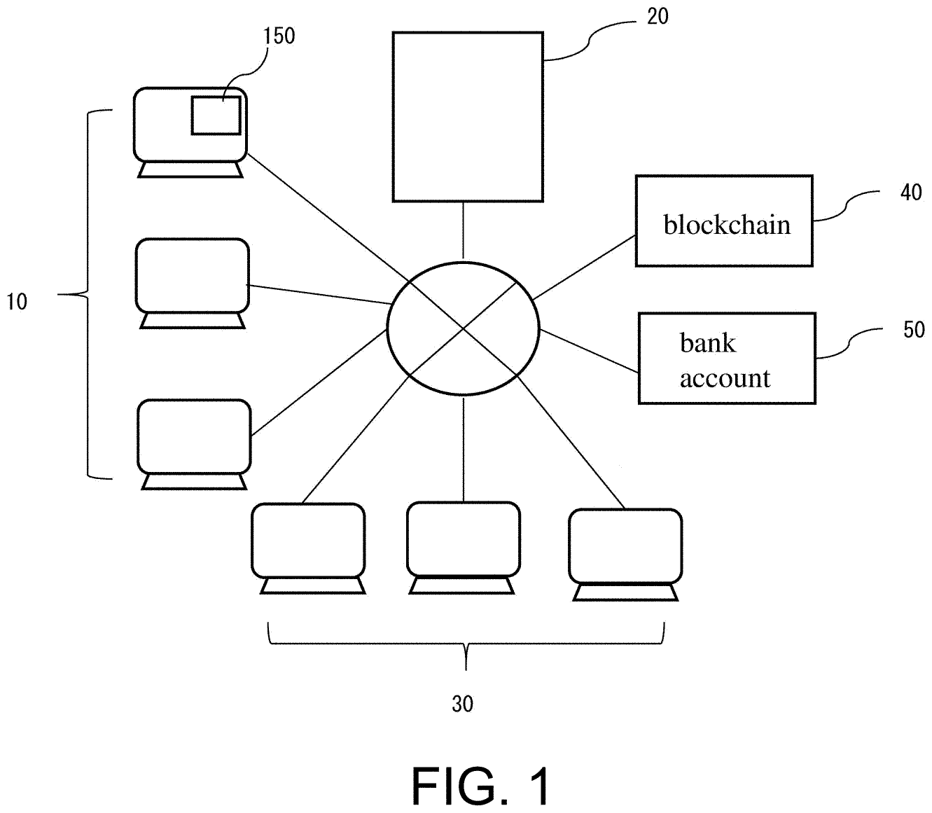

FIG. 1 is a network configuration diagram to which the payment assistance system according to the present embodiment is applied. A purchaser terminal 10, an intermediary server 20, a merchant (seller) terminal 30, and a block chain 40 are connected to each other via a network. Although a large number of terminals are connected to the purchaser terminal 10 and the merchant (seller) terminal 30, one of the terminals to be connected will be described as an example in the present embodiment.

The purchaser terminal 10 is a terminal of a general purchaser who purchases a product, and is illustrated as an example of a terminal of a personal computer, but a connection using, for example, a smartphone is also common. The purchaser executes the purchase processing of the product via the display screen of the purchaser terminal 10. The display screen 150 is displayed, for example, by a browser of a display screen.

The merchant (seller) terminal 30 is, for example, a terminal on the side of a merchant who sells goods such as an EC site. The purchaser accesses the merchant (seller) terminal 30 from the purchaser terminal 10 by accessing the seller terminal 30 via the network, and performs feedback from the seller terminal 30. The merchant terminal 30 includes a merchant web page 100. By accessing the seller terminal 30 from the purchaser terminal 10, the merchant (seller) web page 100 is displayed on the display screen 150.

The intermediary server 20 performs a part of processing between the purchaser terminal 10 and the seller terminal 30. Usually, although the payment processing is completed only between the purchaser terminal 10 and the seller terminal 30, the mediation server 20 executes a function of aggregating and executing at least part of the functions so as not to disperse the payment processing from the purchaser terminal 10 among the various seller terminals 30.

The intermediary (facilitator) server 20 also includes an intermediary web page 110, similar to the merchant terminal 30. By accessing intermediary (facilitator) server 20 from the purchaser terminal 10, the intermediary (facilitator) web page 110 is displayed on the display screen 150. However, the intermediary (facilitator) web page 110 is displayed on the display screen 150 by being incorporated in the merchant web page 100. This mechanism will be described later.

### (A Hardware Configuration Such as a Server)

The hardware configuration of the purchaser terminal 10, the facilitator server 20, and the seller terminal 30 will be described. The purchaser terminal 10, the facilitator server 20, and the seller terminal 30 include a central processing unit (CPU), a read only memory (ROM), a random access memory (RAM), an image processing unit, and a memory. The CPU, the ROM, the RAM, the image processing unit, and the memory are connected to each other via a bus.

The CPU executes various processes in accordance with a program stored in the ROM or a program loaded from the memory into the RAM. In the RAM, data and the like necessary for the CPU to execute various kinds of processing are also stored as appropriate.

The image processing unit includes a digital signal processor (DSP), a video random access memory (VRAM), and the like, and performs various types of image processing on the image data in cooperation with the CPU. For example, image processing such as noise reduction, white balance adjustment, and camera shake correction is performed.

Examples of the memory include a DRAM, a cache memory, a magnetic disk, an optical disk, a magneto-optical disk, or some storage medium such as a semiconductor memory. The memory includes not only those that are connected by a bus, but also those that are read and written via a drive. The data stored in the present embodiment is assumed to be temporarily stored in the memory in the case of temporary storage or long-term storage by the nonvolatile memory.

An input/output interface is connected to the purchaser terminal 10, the intermediary server 20, and the seller terminal 30. A display unit, an input unit, and a communication unit are connected via an input/output interface. The input unit includes various buttons, and receives a user s instruction operation. The communication unit controls communication with another device via a network including the Internet.

The display unit has a display screen, and includes a display device that displays and reproduces an image or video formed by the image processing unit. As the display device, various types of display devices such as a monitor and a liquid crystal display are assumed. In the present embodiment, image data to be displayed is generated by a CPU or the like, and image display processing is performed on the display screen via the image processing unit. Hereinafter, when the description is simply referred to as “display”, the display processing including the functions described above is executed.

Each functional configuration is functionally realized by a cooperative operation of a CPU, a ROM, a RAM, an image processing unit, and a memory. The function of each unit is a module configuration provided by an electronic circuit or a program, and the program is stored in the ROM and executed by the CPU in cooperation with each unit while appropriately reading out the program.

In the present embodiment, the expression “virtual currency” is used, which is a general term of electronic currency to be traded in a exchange by a transaction using a cipher such as a bit coin or an Ethereum frame. The expression is not a virtual currency, but may be referred to as, for example, cryptocurrency. In the present embodiment, the expression “virtual currency” is used.

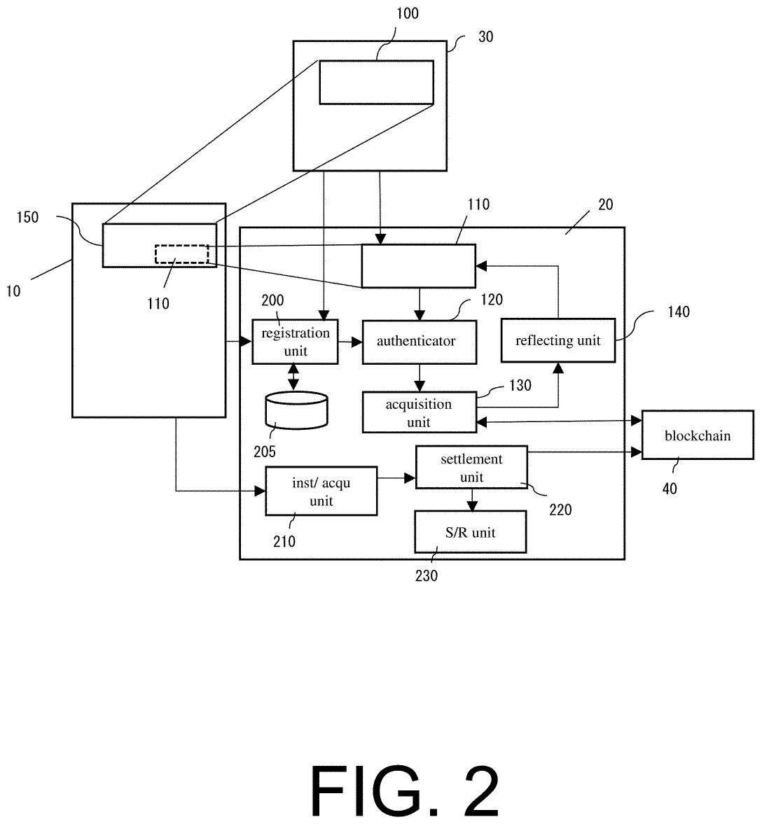

FIG. 2 is a functional block diagram of the payment assistance system according to the present embodiment. The primary function of the payment assistance system is realized by the intermediary server 20. Here, a payment assistance system implemented as the intermediary server 20 will be described with reference to FIG. 2. The payment assistance system is a main configuration of the intermediary server 20, but may be considered to include the purchaser terminal 10, the seller terminal 30, and other information processing apparatuses connected in a wired or wireless manner.

The merchant web page 100 is a web page that is described by html/css and displays the photograph, price, and other product information of the product sold by the seller. The URL assigned to the product information is stored in the storage in the seller terminal 30. The merchant web page 100 is configured to allow the facilitator web page 110 to be displayed together with the merchant web page 100 by including the URL address of the intermediary web page 110 within the inline frame. The URL of the merchant web page 100 is provided at all separately from the intermediary web page 110.

In the present embodiment, the seller web page 100 will be described mainly in a case where the URL address of the intermediary web page 110 is included in the inline frame, but a method using an object tag as a code format to describe the body may also be used. To illustrate, the merchant web page 100 will describe the URL address of the facilitator web page 110 in the html code indicating the capture of other independent pages. As a result, the facilitator web page can be displayed together with the seller web page,

The facilitator web page 110 corresponds to a URL address based on the merchandise identification information of the merchandise selected by the purchaser on the merchant web page 100. The product identification information includes, for example, an ID assigned to each product sold by the seller. The URL address based on the product identification information is formed by describing the assigned ID in communication with the URL indicating the domain of the intermediary web page 110. The intermediary web page 110 itself is stored in the storage in the intermediary server 20 in association with the assigned URL.

The authentication unit (authenticator) 120 authenticates the purchaser (buyer) who has accessed the facilitator web page 110 via the merchant web page 100. Specifically, a list is provided to the intermediary server 20, and whether or not a purchaser who has registered in advance matches with a registered purchaser is authenticated by, for example, a password on the list provided. As a result of the authentication, the purchaser in the list is identified.

For example, the registration unit 200 registers the purchaser and the access information to the block chain 40 for the purchaser in association with each other. The access information is a data necessary for settlement of a virtual currency including information and a password for specifying a purchaser. When registering with the registration unit, the authentication unit 120 authenticates the system use permission from the purchaser based on the information registered in the registration unit 200. Alternatively, if the purchaser (buyer) has accessed the facilitator web page 110 while the seller has logged into the merchant web page 100, the authentication unit 120 may authenticate the purchaser by obtaining login information from the merchant device to which the merchant web page 100 belongs.

The acquisition unit 130 accesses the block chain based on the registration information of the purchaser authenticated by the authentication unit 120 to acquire the balance information of the virtual currency of the purchaser. The acquisition unit 130 acquires balance information based on access to the block chain 40 when the purchaser is authenticated by the authentication unit 120.

The reflecting unit 140 reflects the balance information acquired by the acquiring unit 130 on the intermediary web page 110. The balance information displayed on the intermediary web page 110 is updated with the acquired information. When the balance changes due to settlement or crediting, the reflecting unit 140 updates the balance to a new balance.

The instruction acquisition unit 210 acquires a purchase instruction of a product by the purchaser via the seller web page 100 by the intermediary web page 110. Based on the purchase instruction, the settlement unit 220 executes a purchase settlement for the purchaser with respect to the block chain.

For the purchase settlement, a single purchase instruction may be sent to the block chain 40 each time to perform settlement processing, but a plurality of purchases may be remembered and purchased collectively. By combining a plurality of purchases, access to the block chain 40 is not performed, so that a fee due to access to the block chain 40 can be saved.

For this reason, instead of immediately performing the settlement processing on the purchase instruction, the settlement unit 220 first acquires balance information from the block chain 40, and stores the total amount of the purchase amount within the range of the balance. The settlement unit 220 checks that the total amount of the purchase amount does not exceed the balance, and rejects reception of the purchase when the amount exceeds the balance.

That is, the settlement unit 220 stores the amount and the product in association with the single or a plurality of purchase instructions, checks that the total amount of money does not exceed the balance, and executes a process of executing a single or a plurality of purchase transactions from the purchaser to the intermediary with respect to the block chain. The sending/receiving unit 230 sends the virtual currency obtained by the settlement by the settlement unit 220 to the block chain 40 and performs settlement processing to send the virtual currency to the address owned by the seller from the intermediary server 20.

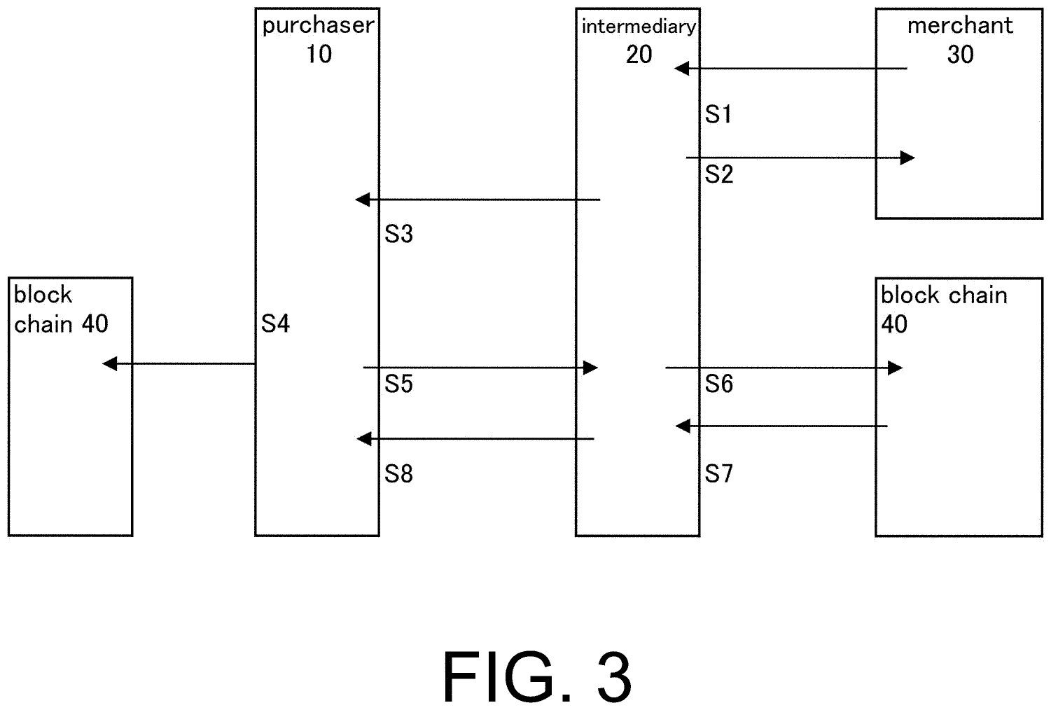

FIG. 3 is a flowchart of the pre-processing of the purchase acceptance via the virtual currency. The registration unit 200 executes the series of processes illustrated in FIG. 3. The registration information registered by the registration unit 200 is stored in a database (DB) 205.

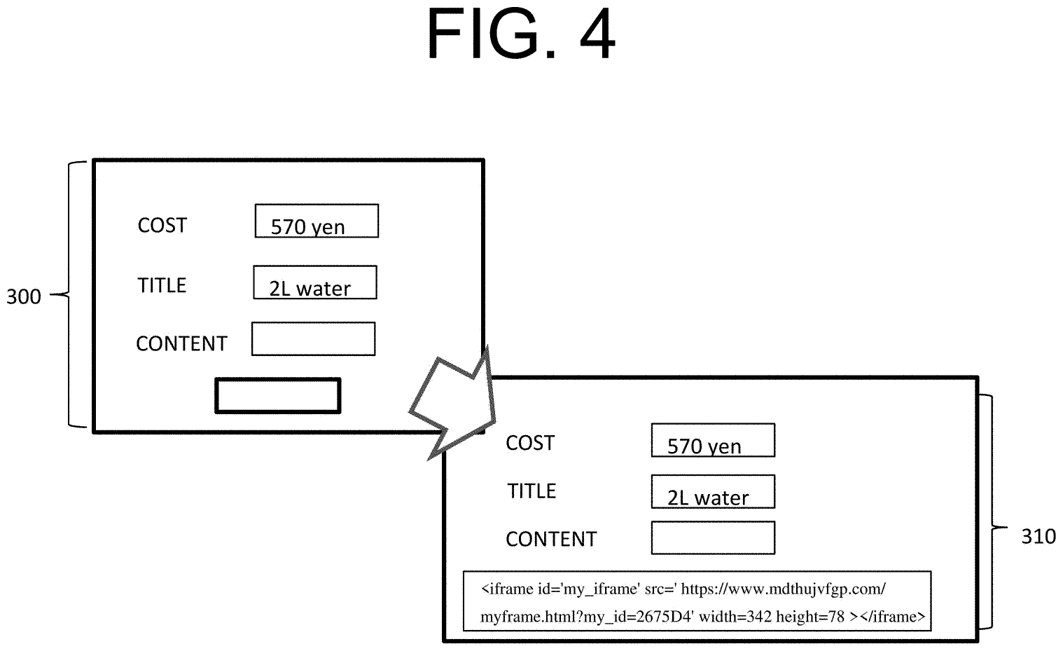

First, the seller terminal 30 sends a component creation request and a withdrawal account registration request to the registration unit 20 (Step S1). In response to the request, the registration unit 200 returns the created component to the seller terminal 3 (Step S2 (Step S2). The production process of the product purchasing component will be described with reference to FIG. 4.

FIG. 4 shows a creation screen of a product purchasing component. The display screen illustrated in the upper left of FIG. 4 is a web page provided in the intermediary server 20. By accessing this web page from the seller terminal 30, the web page shown in FIG. 4 is displayed on the display screen of the seller terminal 30. The display screen includes an input area 300, and a product description is input from the seller terminal 30 by inputting it to the input area 300.

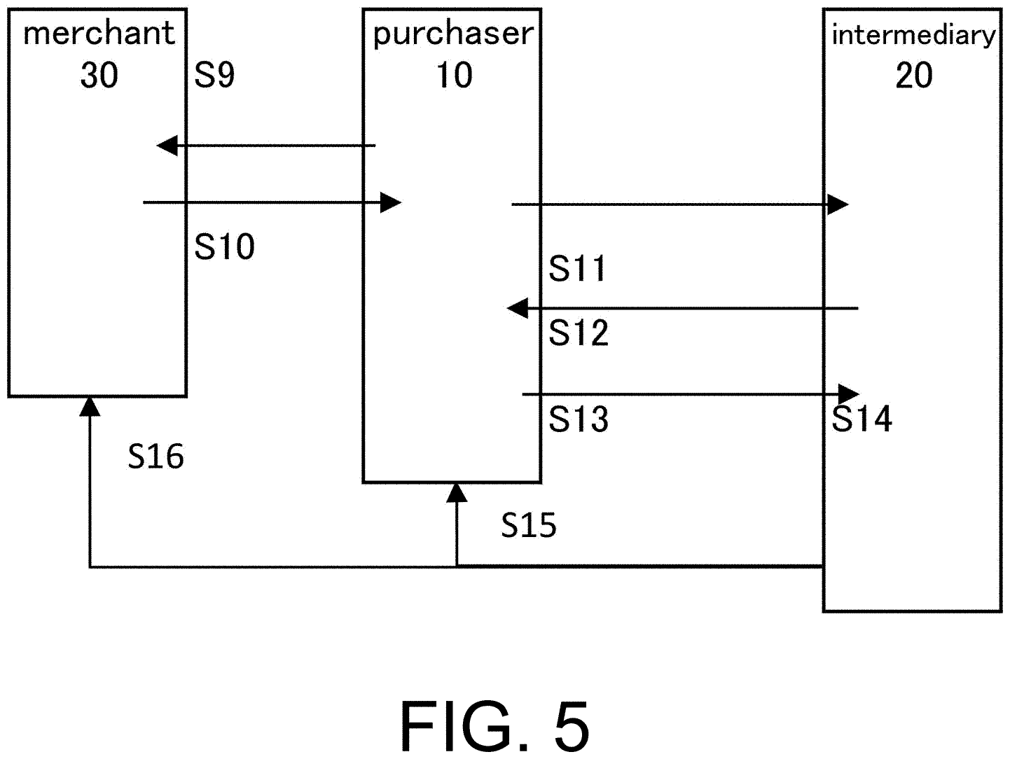

When the input of the product description is completed and the send button is pressed, the display screen shown in the lower right part of FIG. 4 is displayed. Based on the product description input to the input area 300, a series of codes based on html is created and used as a display component. As a result of reproducing the display component on the browser, the display component 310 is displayed. As shown in the lower right part of FIG. 4, the display component 310 includes a banner including a product name, a product price, and a product description. The created display component is assumed to be the web page 110 for the intermediary person as the web data. The URL of the facilitator web page 110 includes the product identification information as a URL parameter. Then, under the display component 310, the URL of the intermediary web page 110 is displayed as an embedded code. The embedded code is a series of html codes constituting the display command of the banner constituting the display component 310, and specifically, will be described with reference to step S10 in FIG. 5.

Here, the flow returns to the flowchart of FIG. 3 again. By receiving the provision of the component, a web page for balance display can be created, and the processing on the seller terminal 30 side is completed. Next, a setting process on the purchaser terminal 10 side is performed. The purchaser performs the dispensing process of the virtual currency to the intermediary such that the product can be purchased when necessary.

First, the intermediary server 20 notifies the purchaser terminal 10 of an address related to the virtual currency of the intermediary (Step S3). The purchaser who has received the notification accesses the block chain 40 from the purchaser terminal 10, and performs a money payment request process such as a virtual currency to the notified address of the intermediary (Step S4). After the dispensing process is completed, the purchaser terminal 10 reports the withdrawal completion report to the intermediary server 20 (Step S5).

Then, the intermediary server 20 accesses the block chain 40 to refer to dispensing from the purchase (Step S6). As a result of the reference, it is confirmed that the data is captured in the block chain (step S7), and the intermediary server 20 issues an ID to the purchaser (step S8), and transmits the ID to the purchaser terminal 10. The purchaser terminal 10 stores the ID in the storage.

The embedded components described in steps S1, s2, and FIG. 4 will be described in detail. The embedded component can be expressed as follows in the html format:

<iframe id=‘my_iframe’
src=‘https://www.mdthujvfgp.com/myframe.html?my_id=2675D4’
width=162 height=78 ></iframe>

Here, it is to be noted: https://www.mdthujvfgp.com/, which is an example of an intermediary URL. By specifying my_id which is an example of the product identification information, it is possible to specify the ID of a component that has been created in advance. In the example described above, my_id=2675D4 indicating product identification information. A program that can be executed by a browser of a user (purchaser) is downloaded from the intermediary server 20 and is automatically executed in the browser. In this case, a button can be displayed or a balance inquiry can be inquired to the intermediary or block chain.

FIG. 5 is a flowchart of the purchase processing via the virtual currency. By accessing the seller s web page 100, the purchaser terminal 10 accesses the seller server 20 in a sense of shopping from the seller terminal 30, and realizes browsing and product purchase of the product price. The series of processes will be described.

The purchaser makes a product viewing request from the merchant web page 10 (Step S9). That is, the purchaser terminal 10 is the URL of the merchant web page 100: https://test.com/seller.html. Then, the product and the component are displayed on the purchaser terminal 10 sid (Step S10). That is, the following html is sent from the seller terminal 30 to the purchaser terminal 10:

<html>
<body>

<img src=‘./water.jpg’>
<iframe id=‘my_iframe’ src=‘

https://www.mdthujvfgp.com/myframe.html?my_id=2675D4’
width=342 height=78 ></iframe></body>
</html>

In the html of the seller web page 100 described above, a code by iframe (inline frame) is described. That is, another page is captured in the merchant web page 100 in the form of an inline frame. This object to be captured is a target to be captured: https://www.mdthujvfgp.com/myframe.html?my_id=2675D4, requesting the URL of the intermediary web page 110. Information of a virtual currency address for each purchaser is managed in the facilitator web page 110. It should be noted that my_id=2675D4 designated here is stored in the storage of the purchaser terminal 10 in step S8.

Since the facilitator web page 110 displayed in the inline frame includes the display of balance information, the purchaser terminal 10 requests inquiry of balance information to the intermediary server 20 (Step S11). The facilitator server 20 displays a balance and a price in response to the request (Step S12).

Specifically, in response to the request, the following html is sent from the intermediary to the purchaser. The following html indicates the facilitator web page 110:

<HTML>
<HEAD>

<META http-equiv=“Content-Type” content=“text/html;>

</HEAD>
<BODY>

<input type=‘hidden’ id=‘title’ value=‘ [symbol] 2 [symbol] ’>

<input type=‘hidden’ id=‘price’ value=‘−100’>
<input type=‘hidden’ id=‘currencyUnit’ value=‘yen’>
<input type=‘hidden’ id=‘giveprice’ value=‘NOTHING’>
<input type=‘hidden’ id=‘giveCurrencyUnit’
value=‘NOTHING’>
<input type=‘hidden’ id=“Body” value = “Water collected from

a clean river”. Provided at low cost>

<input type=‘hidden’ id=‘url’

value=‘http://www.mdthujvfgp.com/mypage.html’>

<script src=“ https://www.mdthujvfgp.com/script.js”></script>

<canvas id=“myCamvas” width=0 height=0></canvas>

</BODY>
</HTML>

A character to be displayed on the button is embedded together with the program code exchanged with the intermediary server:

Canvas: Display region

Script.js: Program code

Title: Product name

Price: Price

CurrencyUnit: Currency name

Giveprice: Gifting amount

GiveCurrencyUnit: Gifting currency name

Url: URL with parts attached thereto

Next, the balance information is acquired and displayed via the application. The parts of the seller web page 100 are displayed as buttons on the display screen 150. The URL of the merchant web page 110 with the balance that the purchaser brings the mouse over the mouse: https://www.mdthujvfgp.com/ is queried to obtain a balance and display it on the button. At this time, by executing the program acquired from the intermediary server 20, the balance and the price inquiry to be displayed on the display screen 150 are executed. By confirming that the seller web page or the domain coincides with the domain included in the url and the url, it is possible to prevent spoofing and ensure security.

First, from the purchaser terminal 10, the URL of the facilitator web page 110 is obtained: Request: https://www.mdthujvfgp.com/script.js. The script program is sent from the intermediary server 20 to the purchaser terminal 10, and is executed on the display screen 150. On the display screen 150, a button is displayed on a button object of all pages <canvas id=“myCamvas” width=0 height=0></canvas>, and a price is also displayed. Then, the purchaser terminal 10 access to the following URL:
https://www.mdthujvfgp.com/command/GET_INFO&2675D4&59014246D887CC D7&b802531d14d1709aa3391b27adc1818fce31612f
My_id that identifies a product: 2675D4
Id representing session: 59014246D887CCD7
User ID and ID for authenticating User generated from password: b802531d14d1709aa3391b27adc1818fce31612f

The intermediary server 20 makes a balance inquiry to the block chain 40 based on the information of the address on block chain received in advance from the purchaser terminal 10 to the intermediary server 20, and acquires the balance (Balance). Note that this process may be performed in advance. The following data is sent from the intermediary to the purchaser. Some of the information overlaps information described later:
Owner=0; Soldout=0; Balance=0; KeyCurrencyName=yen; KeyCurrencyBalance=0; Donor=1; Rate=--; Url=http://www.mdthujvfgp.com/mypage.html;
Owner: Owned or owned
Soldout: Sold or sold
Balance: Balance
KeyCurrencyUnit: Base currency
KeyCurrencyBalane: Base currency conversion balance
Donor: Whether a publisher is a publisher
Url: URL with parts attached thereto

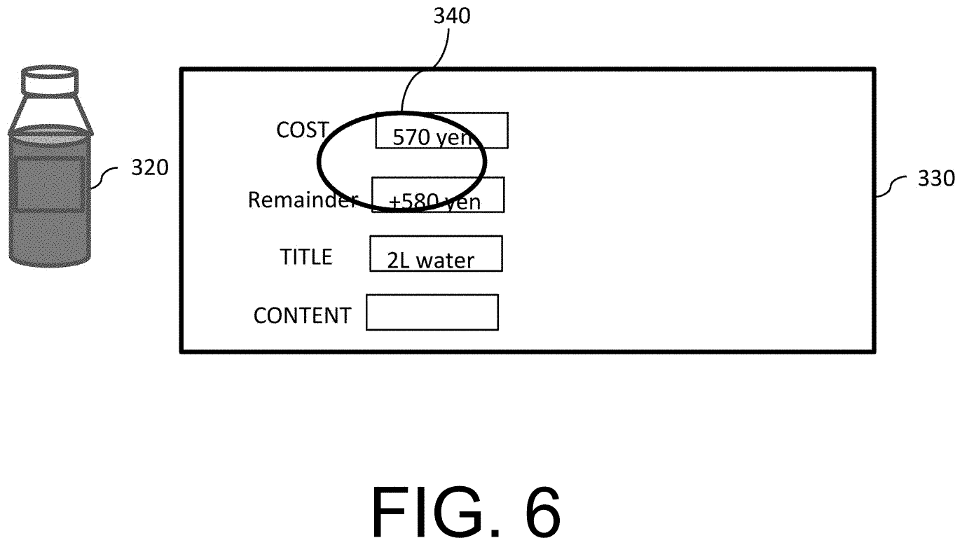

FIG. 6 shows a display screen of the product purchase ticket before the product is purchased. The product photograph 320 and the product description 330 are displayed by displaying the seller web page 100. As described above, the product description 330 is an inline frame display and displays the contents of the facilitator web page 110.

A price balance indication 340 is included in the product description 330. The price balance display 340 includes information on the price of the product and the balance of the virtual currency possessed by the purchaser. If the balance is denominated in yen, the yen amount can be displayed as it is, but since virtual currencies are not usually denominated in yen, the original balance is converted into yen and the yen-converted amount is displayed as this balance.

Returning to FIG. 5, the purchase processing will be described. Since the display processing for the inquiry of the balance is executed, the product is purchased in response to an instruction from the purchaser. Pressing a button, the URL of the facilitator web page 110: https://www.mdthujvfgp.com/ is accessed to perform the purchase processing by the intermediary server 20, and the purchased product is displayed on the display screen 150 of the purchaser terminal 10. First, a purchase request is sent from the purchaser terminal 10 to the intermediary web page 11 (Step S13). The facilitator server 20 receives the purchase request and reduces the internal balance of the purchase (Step S14). Transmitting a purchase completion notification (Steps S15 and S16).

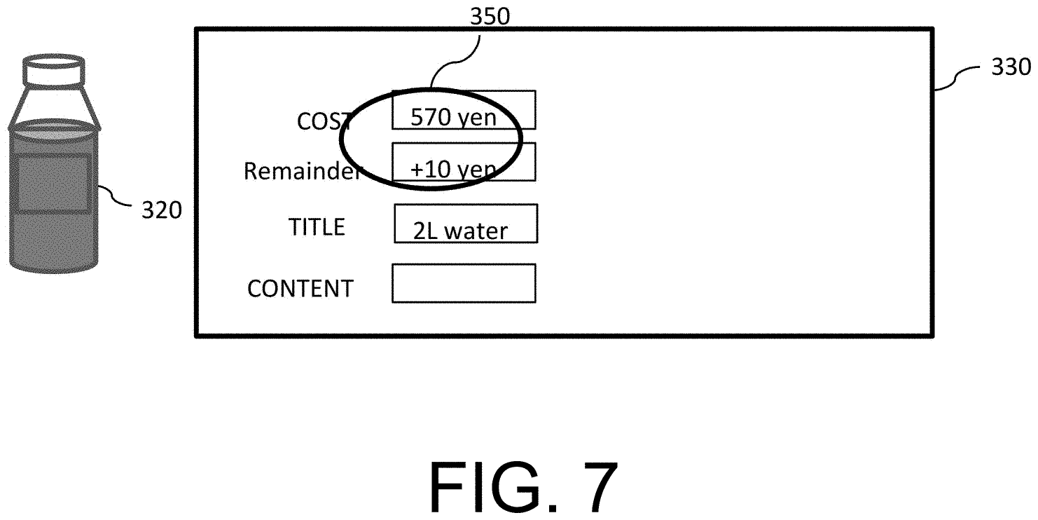

FIG. 7 shows a display screen of the product purchase ticket after the product is purchased. A screen display in a state in which the settlement processing ends while the seller web page 100 is displayed will be described. The product photograph 320 and the product description 330 remain displayed. When the balance shown in the price balance display 340 shown in FIG. 6 is 580 yen, the price balance display 350 becomes as shown in the price balance display 350 after the settlement. That is, the balance 10 yen is obtained by subtracting the product price 570 yen from the original balance 580 yen, and this balance 10 yen is displayed on the price balance display 350. This indicates that the balance is reduced due to the purchase, the shape of the button is changed, the color of the button is changed, or the color of the button is changed, for example, to clearly indicate to the purchaser. In addition, a notification is sent from the intermediary server to the seller and the purchaser, and the service sold by the seller is started by the settlement.

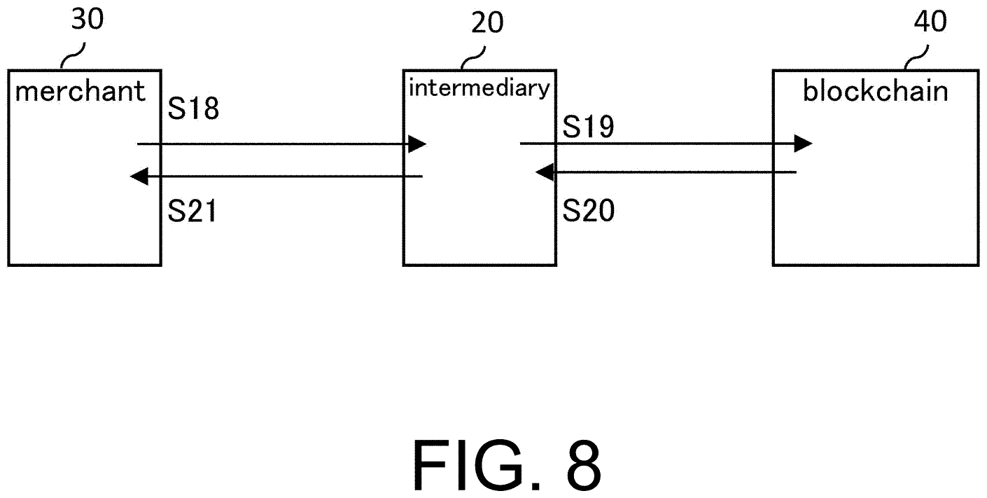

FIG. 8 is a flowchart illustrating a seller dispensing method in the case of virtual currency. As described with reference to FIGS. 5 to 7, after the price and the balance of the virtual currency are indicated to the purchaser and the purchase transaction is performed between the purchaser and the intermediary, the clearing process is performed between the purchaser and the seller.

The seller terminal 30 sends a payment request to the intermediary server 20 (Step S18). The intermediary server 20 sends a payment request to the block chain 40 (Step S19). The request for the payment request indicates that the request is sent from the virtual currency address of the intermediary to the virtual currency address of the seller.

After the payment request to the block chain 40, the intermediary server 20 sends a reference request to the block chain 40 (step S20), and confirms that the product price held by the intermediary is captured in the block chain 40. After the confirmation, the facilitator server 20 sends a withdrawal completion notification to the seller terminal 3 (Step S21).

As described above, the facilitator web page 110 is the product identification information (my_id) of the product: 2675D4) based on a URL address (such as: https://www.mdthujvfgp.com/myframe.html?my_id=2675D4). Thus, for example, if the purchaser selects a product on the merchant web page 100, the facilitator web page 110 may be captured and displayed within the inline frame within the merchant web page 100.

In this way, by enabling the facilitator web page 110 to be captured in the seller web page 100, the balance confirmation processing of the virtual currency can be collectively processed in the intermediary web page 110 without preparing for each of the seller web pages 100. Since the purchaser actually accesses the facilitator web page 110, it authenticates and allows acquisition of balance information and obtains balance information. Since the acquired balance information is reflected on the facilitator web page 110, the purchaser can continue to perform the purchase processing while viewing the merchant web page 100.

That is, by managing the balance by managing the virtual currency address received from the customer on the intermediary side and referring to the intermediary during the settlement, the balance can be confirmed, and the payment confirmation screen can be displayed in an easy-to-view manner, and the settlement operation can be performed without switching the screen on the same screen.

Further, since the balance can be confirmed by managing the balance by managing the secret key on the intermediary side, the balance can be confirmed by referring to the intermediary, and the payment confirmation screen can be displayed in an easy-to-view manner, and the settlement operation can be performed without switching the screen on the same screen.

In particular, it is possible to clearly show that a product can be purchased by displaying a part with a button. In addition to the balance display, a QR code (registered trademark) representing an address (account) of a virtual currency for depositing a photograph of a product, a photograph of a product, or an address of a virtual currency, or a URL/QR code (registered trademark) for displaying a part may be clearly displayed. In addition, when the currency type of the presented price and the currency type of the balance are different in the price and the balance display, it is possible to display the currency in terms of the currency in which the balance is displayed (based on the rate that can be exchanged by the intermediary). In the case where the currency of the price presented also in the settlement is different from the currency of the balance displayed, the facilitator replaces the currency in which the balance is displayed and provides the currency to the seller.

Some or all of the processing performed by the intermediary server 20 may be downloaded from the intermediary server 20 to the purchaser's terminal 10 as a trusted program code, and then the program code may be executed on the purchaser's terminal 10. In such a case, the blockchain 40 is accessed directly from the purchaser's terminal 10, not via the intermediary server 20.

### Other Embodiment 1

Although the above embodiment has described the product purchase by the virtual currency and the settlement processing in this case, it is also possible to substitute this by the bank account 50, and thus the case where the settlement of the product is performed by the bank account 50 will be described. As in the embodiment described above, since the intermediary server 20 is interposed between the purchaser terminal 10 and the seller terminal 30, the system configuration diagram and the display screen 150 are omitted, but FIG. 1, FIG. 2, FIG. 4, FIG. 6, and FIG. 7 are common to other embodiments described later.

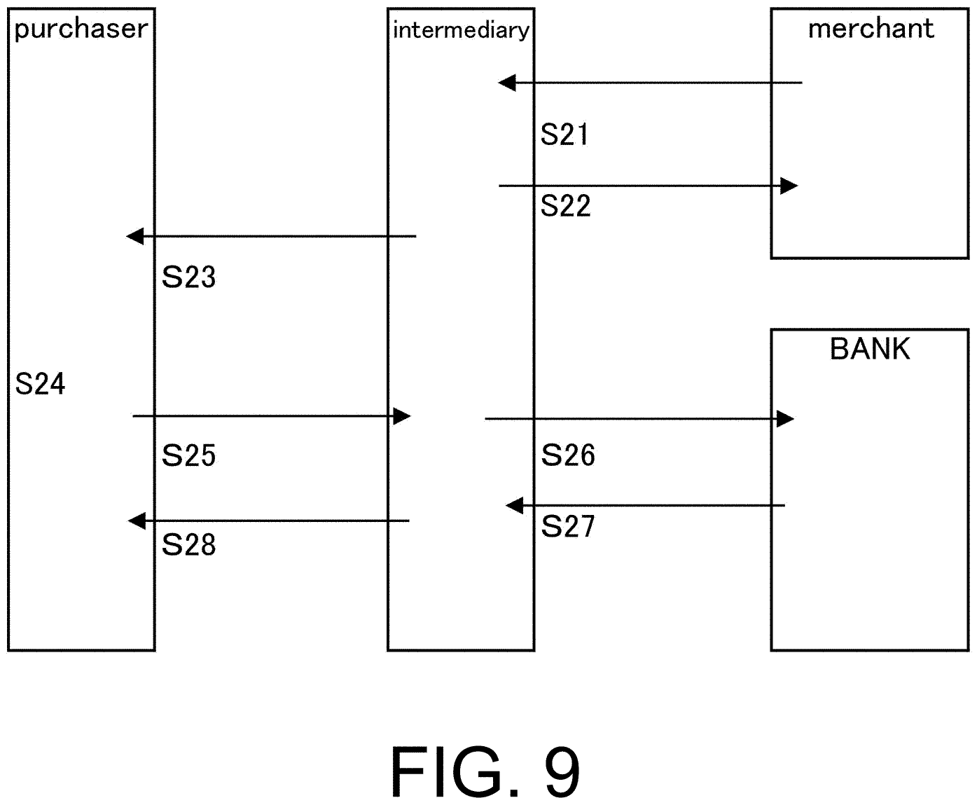

FIG. 9 is a flowchart of the preprocessing of the purchase acceptance via the bank account. The series of processing illustrated in FIG. 9 is similar to that illustrated in FIG. 3, and is executed by the registration unit 200. The registration information registered by the registration unit 200 is stored in a database (DB) 205.

First, the registration unit 200 sends a component creation request and a withdrawal account registration request to the seller terminal 3 (Step S21). In response to the request, the seller terminal 30 returns the created part to the intermediary server 20 (Step S22). The product purchasing component creation screen is as described with reference to FIG. 4.

By receiving the provision of the component, a web page for balance display can be created, and the processing on the seller terminal 30 side is completed. Next, a setting process on the purchaser terminal 10 side is performed. The purchaser performs the dispensing process of the virtual currency to the intermediary such that the product can be purchased when necessary.

First, the facilitator server 20 notifies the purchaser terminal 10 of the bank account 50 of the intermediary (Step S23). The purchaser who has received the notification accesses the account of the bank account 50 from the purchaser terminal 10, and performs the dispensing process to the notified virtual currency address of the intermediary (Step S24). After the dispensing process is completed, the purchaser terminal 10 reports the withdrawal completion report to the intermediary server 20 (Step S25).

The facilitator server 20 then accesses the bank account 50 to make a balance inquiry for dispensing from the purchase (Step S26). As a result of the balance inquiry, when the balance is presented (step S27), the intermediary server 20 issues an ID to the purchaser (step S28), and transmits the ID to the purchaser terminal 10.

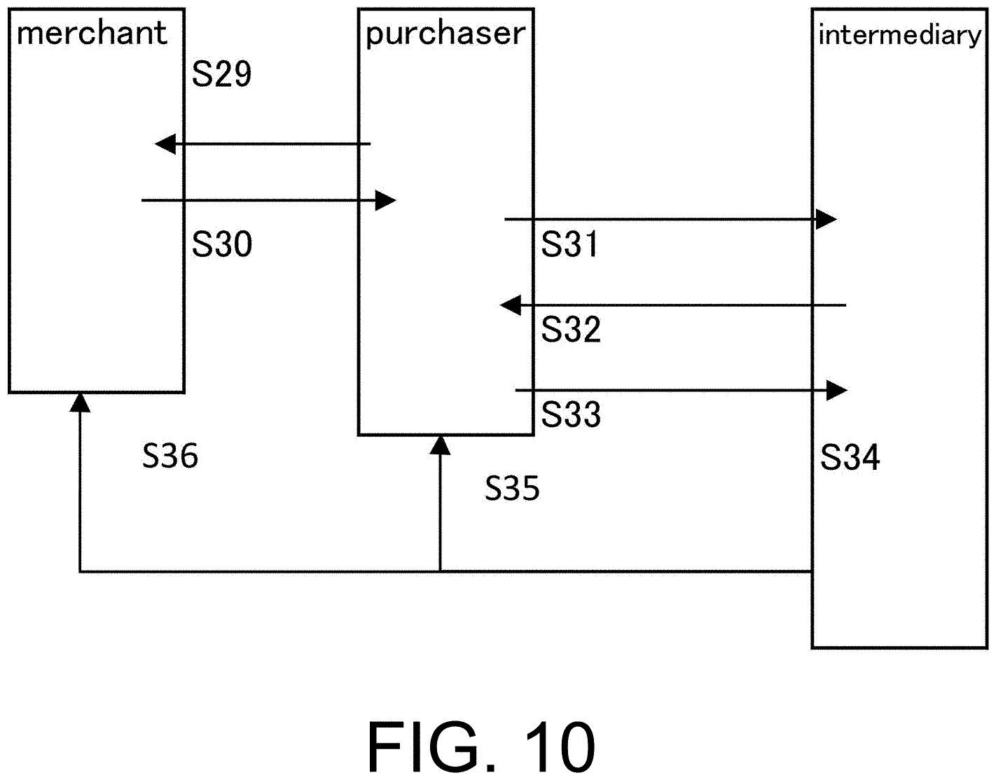

FIG. 10 is a flowchart of the purchase processing via the bank account. FIG. 10 corresponds to FIG. 5. By accessing the seller s web page 100, the purchaser terminal 10 accesses the seller server 20 in a sense of shopping from the seller terminal 30, and realizes browsing and product purchase of the product price. The series of processes will be described.

The purchaser makes a product viewing request from the merchant web page 10 (Step S29). That is, the purchaser terminal 10 is the URL of the merchant web page 100: https://test.com/seller.html. Then, the product and the component are displayed on the purchaser terminal 10 sid (Step S30). Since html to be sent is the same as that in FIG. 5, a description thereof will be omitted.

Since the facilitator web page 110 displayed in the inline frame includes the display of balance information, the purchaser terminal 10 requests inquiry of balance information to the intermediary server 20 (Step S31). The facilitator server 20 displays a balance and a price in response to the request (Step S32).

Next, purchase processing will be described. Since the display processing for the inquiry of the balance is executed, the product is purchased in response to an instruction from the purchaser. Pressing a button, the URL of the facilitator web page 110: https://www.mdthujvfgp.com/ is accessed to perform the purchase processing by the intermediary server 20, and the purchased product is displayed on the display screen 150 of the purchaser terminal 10. First, a purchase request is sent from the purchaser terminal 10 to the intermediary web page 11 (Step S33). The facilitator server 20 receives the purchase request and reduces the internal balance of the purchase (Step S34). Transmitting a purchase completion notification (Steps S35 and S36).

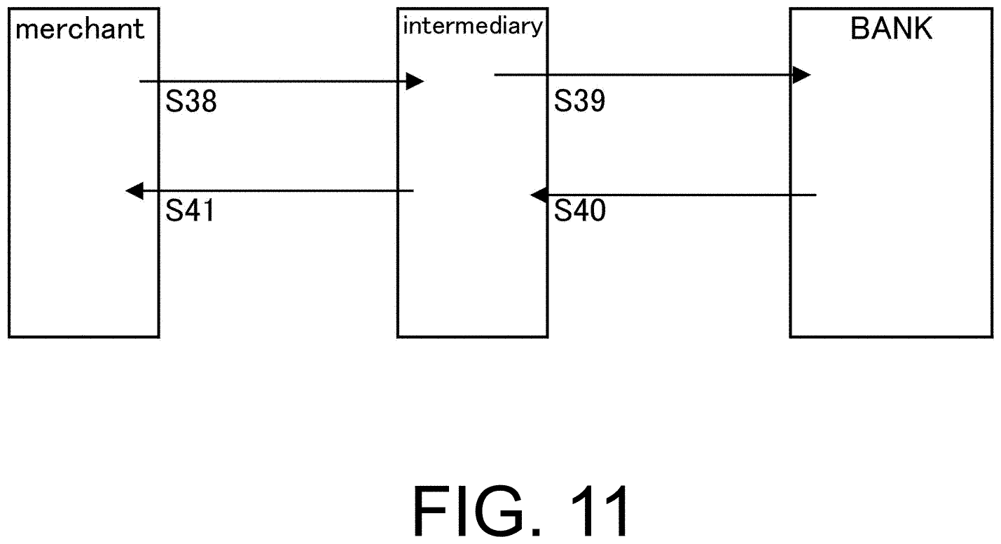

FIG. 11 is a flowchart illustrating a seller dispensing method in the case of a bank account, and corresponds to FIG. 8. As described above, after the price and account balance is indicated to the purchaser and the purchase transaction is made between the purchaser and the intermediary, the clearing process is now performed between the facilitator and the merchant.

The seller terminal 30 sends a withdrawal request to the intermediary server 20 (Step S38). The intermediary server 20 sends a payment request to the block chain 40 (Step S39). The request for the payment request indicates that the request is sent from the virtual currency address of the intermediary to the virtual currency address of the seller. This is because the purchaser deposits the purchase price once from the purchaser.

After the payment request to the bank account 50 is received and dispensed, a dispensing completion notification is sent to the facilitator server 20 (step S40), and the intermediary server 20 sends a dispensing completion notification to the seller terminal 3 (Step S41).

As described above, by enabling the facilitator web page 110 to be captured in the merchant web page 100, the balance confirmation processing of the bank account 50 can be collectively processed in the intermediary web page 110 without preparing for each merchant web page 100. Since the purchaser actually accesses the facilitator web page 110, it authenticates and allows acquisition of balance information and obtains balance information. Since the acquired balance information is reflected on the facilitator web page 110, the purchaser can continue to perform the purchase processing while viewing the merchant web page 100.

### Other Embodiment 2

In the embodiment described above, the product purchase by the virtual currency or the bank settlement and the settlement processing in this case were described, but as another example, other cases in which commodities are settled by the virtual currency Bitcoin will be described. As in the embodiment described above, since the intermediary server 20 is interposed between the purchaser terminal 10 and the seller terminal 30, the system configuration diagram and the display screen 150 are omitted, but FIG. 1, FIG. 2, FIG. 4, FIG. 6, and FIG. 7 are common to other embodiments described later.

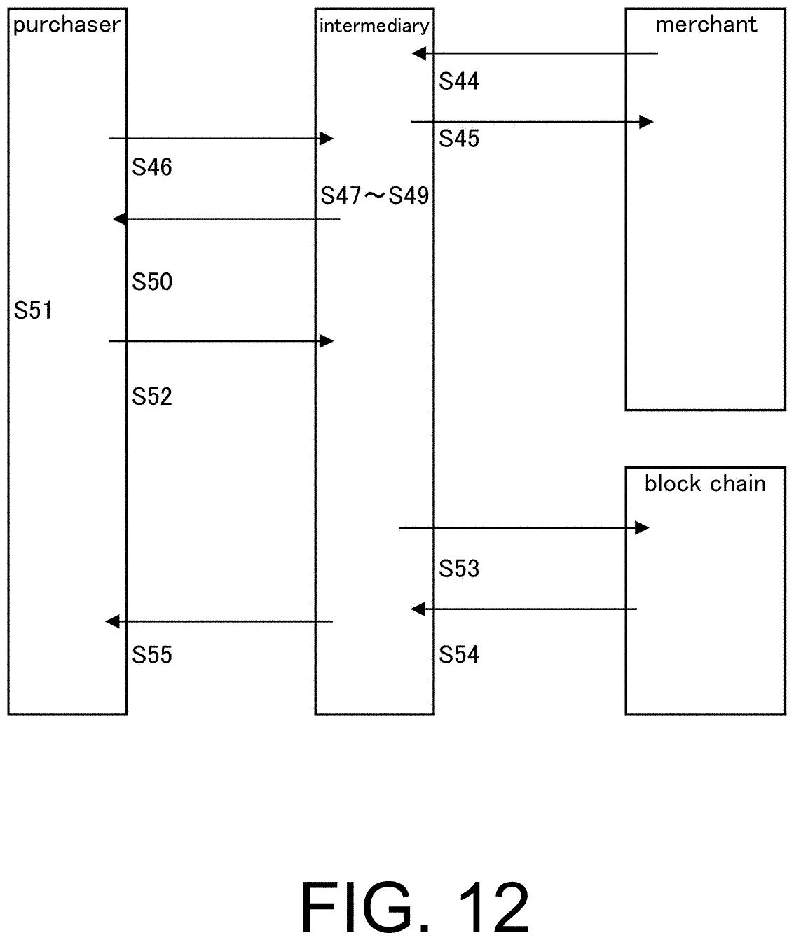

FIG. 12 is a flowchart of the balance display processing by the payment channel via the virtual currency Bitcoin. The series of processing illustrated in FIG. 12 is the same as that illustrated in FIGS. 3 and 9, and is executed by the registration unit 200. The registration information registered by the registration unit 200 is stored in a database (DB) 205.

First, the registration unit 200 sends a component creation request and a withdrawal virtual currency address registration request to the seller terminal 3 (Step S44). In response to the request, the seller terminal 30 returns the created part to the intermediary server 20 (Step S45). The product purchasing component creation screen is as described with reference to FIG. 4.

By receiving the provision of the component, a web page for balance display can be created, and the processing on the seller terminal 30 side is completed. Next, a setting process on the purchaser terminal 10 side is performed. The purchaser performs the dispensing process of the virtual currency Bitcoin to the intermediary such that the product can be purchased when necessary.

Transmitting the ID issuance request from the purchaser terminal 10 to the intermediary server 20 (Step S46). The facilitator server 20 generates a multi-signature that can be released with both the purchaser and the intermediary s private key, and generates a transaction A at which the purchaser dispenses one BTC (Step S47). In addition, a transaction B is generated that returns 1 BTC to the purchaser after one month following transaction (Step S48). Then, the signature of the intermediary person is assigned to the transactions A and (Step S49). The intermediary server 20 sends the signed transactions A and B of the intermediary server 20 to the purchaser terminal 10 (Step S50). At the purchaser terminal 10, the transaction A, b is signed (Step S51). Then, the purchaser terminal 10 sends only the signed transaction A of the intermediary and the purchaser to the intermediary server 20 (Step S52). The transaction B is held by the purchaser.

The intermediary server 20 transmits the transaction A to the block chain 40 (Step S53). Then, in step S54, the intermediary server 20 issues an ID to the purchaser (step S55), and transmits the ID to the purchaser terminal 10 (step S55).

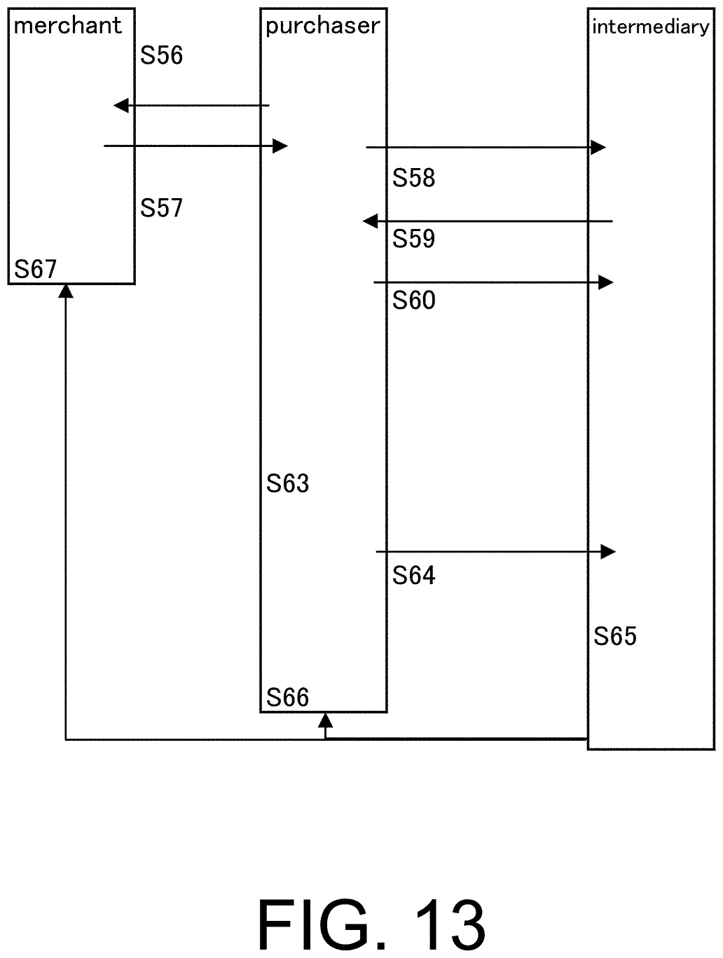

FIG. 13 is a flowchart of the purchase processing by the payment channel via the virtual currency Bitcoin. FIG. 13 corresponds to FIGS. 5 and 10. By accessing the seller s web page 100, the purchaser terminal 10 accesses the seller server 20 in a sense of shopping from the seller terminal 30, and realizes browsing and product purchase of the product price. The series of processes will be described.

The purchaser makes a product viewing request from the merchant web page 10 (Step S56). That is, the purchaser terminal 10 is the URL of the merchant web page 100: https://test.com/seller.html. Then, the product and the component are displayed on the purchaser terminal 10 sid (Step S57). Since html to be sent is the same as that in FIG. 5, a description thereof will be omitted.

Since the facilitator web page 110 displayed in the inline frame includes the display of balance information, the purchaser terminal 10 requests inquiry of balance information to the intermediary server 20 (Step S58). The intermediary server 20 displays a balance (e.g., 1 BTC) and a price (e.g., 0.1 BTC) in response to the request (Step S59).

Next, purchase processing will be described. Since the display processing for the inquiry of the balance is executed, the product is purchased in response to an instruction from the purchaser. Pressing a button, the URL of the facilitator web page 110: https://www.mdthujvfgp.com/ is accessed to perform the purchase processing by the intermediary server 20, and the purchased product is displayed on the display screen 150 of the purchaser terminal 10.

First, a purchase request is sent from the purchaser terminal 10 to the intermediary web page 20 (Step S60).

The purchaser terminal 10 make a transaction C with the balance [Purchaser balance 0.9 BTC], and [intermediary party 0.1 BTC] and sign a transaction C (Step S63). The facilitator server 20 receive a transaction C with the purchaser signature (Step S64). The facilitator server 20 holds the transaction (Step S65). After the series of transactions is completed, the intermediary server 20 sign and sends the transaction C to the block chain. The intermediary server 20 sends a purchase completion notification to the purchaser terminal 10 (step S66), and the intermediary server 20 sends a purchase recognition notification to the seller terminal 3 (Step S67).

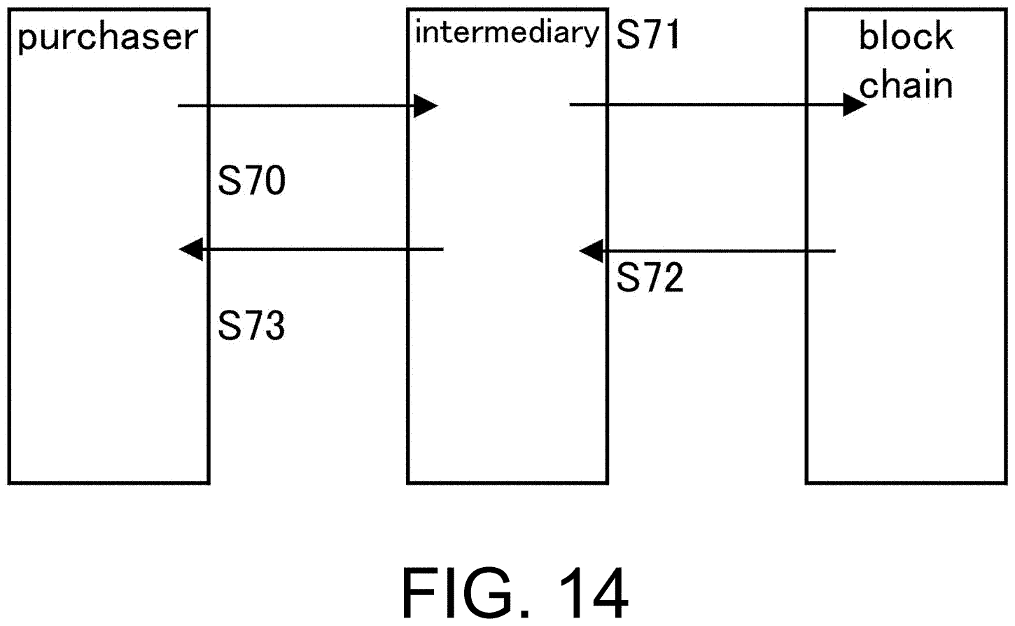

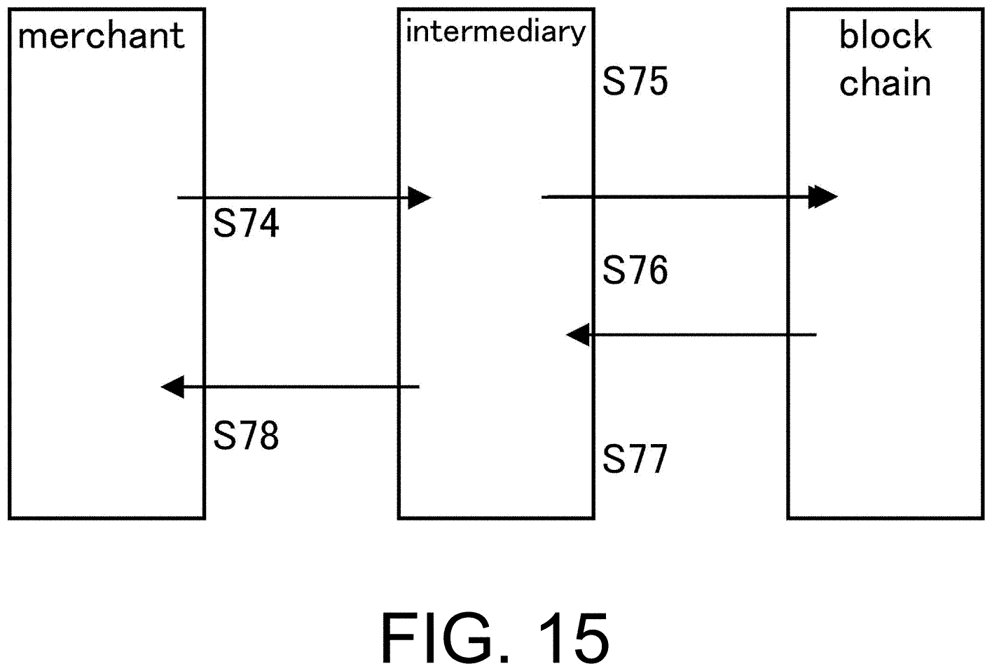

Since the product settlement has been described in the flowchart of FIG. 13, the end of the transaction will be described with reference to FIGS. 14 and 15. FIG. 14 shows the purchaser side and FIG. 15 shows the end transaction on the seller side.

FIG. 14 is a flowchart illustrating a purchaser side trading method of a virtual currency Bitcoin. First, a transaction end request is sent from the purchaser terminal 10 to the intermediary server 20 (Step S70). In response to the purchase request, the intermediary server 20 reflects the end of the transaction in the block chain 40 (Step S71). The facilitator server 20 receives the confirmation of the incorporation into the block chain 40 (step S72), and returns the end of the transaction to the purchaser terminal 10 (Step S73).

FIG. 15 is a flowchart illustrating a method of dispensing a seller of the virtual currency Bitcoin, and corresponds to FIGS. 8 and 11. In turn, a clearing process is performed between the intermediary and the merchant. First, the seller terminal 30 sends a withdrawal request to the intermediary server 20 (Step S74).

The intermediary server 20 sends a payment request to the block chain 40 (Step S75). The request for the payment request indicates that the request is sent from the virtual currency address of the intermediary to the virtual currency address of the seller. This is because the purchaser deposits the purchase price once from the purchaser.

After the payment request to the block chain 40, the intermediary server 20 sends a reference request to the block chain 40 (step S76), and confirms that the product price held by the intermediary is captured in the block chain 40 (Step S77). After the confirmation, the facilitator server 20 sends a withdrawal completion notification to the seller terminal 3 (Step S78).

As described above, the facilitator web page 110 can be captured in the merchant web page 100 and can be processed collectively on the intermediary web page 110 without preparing for each merchant web page 100 by the virtual currency Bitcoin transaction. Since the purchaser actually accesses the facilitator web page 110, it authenticates and allows acquisition of balance information and obtains balance information. Since the acquired balance information is reflected on the facilitator web page 110, the purchaser can continue to perform the purchase processing while viewing the merchant web page 100.

While the present invention has been described with reference to examples, the technical scope of the present invention is not limited to the above embodiments. It is apparent to persons skilled in the art that various alterations and improvements can be added to the above embodiments. It is also apparent from the scope of the claims that the embodiments added with such alterations or improvements can be included in the technical scope of the present invention.

1. A payment assistance system comprising:
an intermediary web page corresponding to a URL address based on product identification information of a product selected by a purchaser on a merchant web page;
an authentication unit that authenticates the purchaser who has accessed the intermediary web page via the merchant web page;
an acquisition unit configured to acquire balance information of a virtual currency of the purchaser by accessing a block chain based on registration information of the purchaser authenticated by the authentication unit; and
a reflection unit configured to reflect the balance information acquired by the acquisition unit in the intermediary web page.

2. The payment assistance system according to claim 1, wherein
the merchant web page displays the intermediary web page and the merchant web page by describing a URL address of the intermediary web page in html codes indicating that intermediary web page is part of merchant web page.

3. The payment assistance system according to claim 1, further comprises
a registration unit that registers the purchaser and the access information to the block chain for the purchaser in association with each other, wherein
the authentication unit authenticates a system use permission from the purchaser based on the information registered in the registration unit, and
the acquisition unit acquires the balance information based on access to the block chain when the purchaser is authenticated by the authentication unit.

4. The payment assistance system according to claim 1, further comprises
an instruction acquisition unit configured to acquire a purchase instruction of a product by the purchaser via the merchant web page by the intermediary web page, and
a payment unit configured to execute a purchase transaction for the purchaser with respect to the block chain based on the purchase instruction.

5. The payment assistance system according to claim 4, further comprises:
a notification unit configured to notify a merchant of the purchase transaction of completion of purchase by the payment unit when the purchase transaction for the purchaser is completed.

6. The payment assistance system according to claim 1, wherein
when accessing the intermediary web page with the purchaser logged into the merchant web page,
the authentication unit authenticates the purchaser by acquiring login information from a merchant apparatus to which the merchant web page belongs.

7. The payment assistance system according to claim 1, wherein the URL address of the intermediary web page includes the product identification information as a URL parameter.

8. A payment assistance method using a payment assistance system, comprising:
displaying a selection screen of a product to receive a selection input, to display product information of a selected product on a merchant web page,
reflecting an intermediary web page in the merchant web page for access to a URL address based on product identification information of the selected item,
authenticating a purchaser who has accessed the intermediary web page via the merchant web page,
acquiring balance information of virtual currency of the purchaser by accessing block chain based on registered information of the authenticated purchaser, and
reflecting the acquired balance information in the intermediary web page.

9. A payment assistance system comprising:
an intermediary web page corresponding to a URL address based on product identification information of a product selected by a purchaser on a merchant web page,
an authentication unit that authenticates the purchaser who has accessed the intermediary web page via the merchant web page,
an acquisition unit configured to acquire balance information of a virtual currency of the purchaser by accessing the block chain based on registration information of the purchaser authenticated by the authentication unit,
an instruction acquisition unit configured to acquire a purchase instruction of a product by the purchaser via the merchant web page by the intermediary web page, and
a payment unit configured to execute a purchase transaction for the purchaser with respect to the block chain based on the purchase instruction,
